(19) United States
(12) Patent Application Publication
(10) Pub. No.: US 2023/0008460 A1
(43) Pub. Date: Jan. 12, 2023

(54) METHOD AND SYSTEM FOR LOGGING EVENT DATA

(71) Applicant: Metakol SRL, Genova (IT)

(72) Inventor: Andrea MUNGO, Pieve Ligure (IT)

(73) Assignee: Metakol SRL, Genova (IT)

(21) Appl. No.: 17/783,652

(22) PCT Filed: Dec. 10, 2020
(86) PCT No.: PCT/IB2020/061737

§ 371 Date: Jun. 9, 2022

(30) Foreign Application Priority Data
Dec. 12, 2019 (IT) 102019000023781

(51) Int. Cl. G06F 21/64; G06F 21/62; G06V 20/59; G06V 20/56

(52) U.S. Cl. CPC G06F 21/64; G06F 21/6209; G06V 20/59; G06V 20/56; G06F 2221/2141

(57) ABSTRACT

The invention relates to a method for asseverating video images, photos, audio-video and/or data in general, acquired from different sources (10, 11, 12, 13), wherein the images are first validated to verify the absence of tampering and then subjected to a step of certifying, in which they are encrypted.

The encrypted images are accessible only to authorised and identified users, who are provided with the decryption code. The invention also comprises a system for implementing the method.

The present invention relates from a more general point of view to the methods, equipment and systems intended for image detection, in particular but not exclusively for road safety, the documentation of events such as accidents in general or other applications that will appear better hereinbelow.

As is known, the application of data or image detection systems, in particular relative to cars, is a field in strong expansion and technological evolution, above all for purposes of road safety, accident insurance and autonomous driving.

In fact, the practice of offering more advantageous insurance policies according to the driving behaviour of the insured, which is detected with special equipment installed on board vehicles (cars, trucks, motorcycles, etc.) is now well established.

These are electronic devices that can be installed on board vehicles as original equipment or subsequently as apparatuses linked to the vehicle insurance.

These devices, also commonly called “black boxes”, detect the driving characteristics of a person, such as speed, acceleration, distances and routes travelled, the geo-localization of the vehicle, allowing to trace a profile of the driver and thus stipulate tailor-made insurance policies for each person.

An evolution of these devices consists in integrating and/or replacing driving information with images recorded on board the vehicle.

This allows the vehicle driving situations to be fully documented, especially in the event of a road accident.

An example of this state of the art is described in the American patent application US 2003/028298 in the name of MACKY et al., which discloses an apparatus that can be positioned on a vehicle such as a car, a van or a bus.

This apparatus comprises a camera, a memory and a two-axis accelerometer, where the memory is provided with a circular buffer that is continuously filled by a data flow generated by the camera and by the accelerometer.

The apparatus is configured to store in a permanent area of the memory the contents of the circular buffer and the data flow generated by the camera and by the accelerometer for a predetermined period of time (for example 20-30 seconds) each time the accelerometer detects at least one acceleration having an intensity associated with that occurring during a road accident.

In this way, the content of the circular buffer relating to the period of time prior to the instant in which the accident occurred and the data flow acquired in the period of time contemporaneous with and subsequent to that of the instant of the accident, are stored in a permanent manner and/or transmitted to an external server through telecommunication means, so as to make possible their subsequent examination by the owner of the vehicle and/or by an insurance company and/or by competent authorities, such as for example the police or other.

This type of vehicular electronic apparatuses (also known by the name of dashcam) has the drawback that the information they generate (films, telemetric data, etc.) during an accident, are difficult to use in legal disputes as it is problematic to verify objectively whether this information is authentic or not.

In other words, there is no certainty that after their generation, the images have not been changed or altered.

In fact, with the programs (software), equipment and technical knowledge available today, people skilled in the art are able to change all or part of the stored digital data that make up the film, so as to alter the veracity of the content with the result that what is seen in the end does not correspond to the reality of the events that occurred previously.

For this reason, the evidential use of the images acquired with devices such as the one described by Macky or with any other means suitable for recording videos (video cameras, mobile phones, etc.) must generally be validated or otherwise verified by an expert called upon to express his opinion on the authenticity and/or integrity of the evidence presented by the parties.

A partial improvement of this situation is described in the international patent application WO2018/193412, which provides for a method that can be implemented through computer systems, such as electronic processors and the like, for validating the images and/or the data acquired with different devices, not only those specifically installed on board vehicles but also those coming from any other source, such as video surveillance cameras, films made with mobile telecommunications terminals (mobile phones, tablets, computers, etc.), VEDR-type event recorders (Video Event Data Recorder), black boxes and so on.

The process described in this document is based on the processing of image-related data, such as the consistency between the place where they were acquired and the time, the telemetric data of the vehicles (speed, acceleration), the environmental conditions (e.g. brightness, meteorology, etc.), or by comparing images and/or data related to the same event but coming from different sources, such as external surveillance cameras (banks, buildings, roads) and those on board a vehicle, including mobile phones or other devices.

Although this state of the art is able to confirm with good results the authenticity of the material (images or films) acquired, it is not able to do the same with regard to the remote transmission of the material to insurances, to databases or in any case to the interested subjects who must receive and/or use it.

Consider, for example, the case of video or photographic images used as trial evidence before the courts, for disputes on damage claims or whatever.

The system described in the American patent application US 2003/028298 Macky et al. does not seem to be able to satisfy this need, since it only envisages encrypting the images and then transmitting them remotely, storing them in the local memory of the equipment on board the vehicle.

The relative local memory is then blocked by the processor, so as to prevent any altered data from being accumulated in the memory itself.

This solution allows to achieve a double level of security against tampering: the first because outsiders who want to access the stored data must have the decryption and encryption codes, while the second is linked to the memory block that prevents access to it.

However, it is understandable that this double level of security only concerns the equipment on board the vehicle, which in practice is a black box similar to those of aircrafts; however, it does not concern, for example, the data transmitted remotely from the equipment which, although encrypted, seem accessible to multiple subjects without particular precautions or security.

Furthermore, the system described in the American patent application US 2003/028298 Macky et al. is limited only to the specific equipment installed on the vehicle: it is therefore not able to operate on the images or on the data acquired by any other means mentioned above, either public or private, i.e. mobile phones, video cameras, surveillance cameras, etc.

In the light of this examination it can therefore be stated that the general technical problem underlying the invention is that of providing a method and an equipment for the implementation thereof, with structural and functional characteristics such as to overcome the drawbacks referred to above in relation to the state of the art.

Within the scope of this technical problem, the invention proposes more specifically to make available a method, a system and an apparatus for asseverating video, photographic images, audio-video and/or data in general, in analogue or digital form, acquired with different apparatuses or devices, which allows not only to prevent the tampering thereof but also to guarantee the authenticity thereof in the various steps of transmission, storage and manipulation.

The invention therefore provides a form of asseverating the images in documentary evidence, which can be used in court or for any other purpose.

The idea of the solution to the technical problem outlined above is to provide a method which preferably operates at least one step of validating, one step of certifying and one step of protecting images and/or documents acquired.

For this purpose, the method of the invention preferably provides for a step of verifying the authenticity of the images to ensure the absence of tampering.

This step is implemented by a processing procedure, which includes among others the computer identification of the author of the document by releasing a digital identity and an access word or code; determining chronological parameters such as date and time, identifying the moment of formation of the document; excluding alterations to the document by analysing one or more parameters such as metadata, brightness, colours, contrasts, image discontinuity or others.

In the event of a positive outcome of the verifications, the document can be encrypted and securely transmitted through a specific procedure, which allows access only to authorised subjects.

The features of the invention are set forth more specifically in the claims appended to this description.

These characteristics, the resulting effects and the advantages achieved by the invention, will become clearer from the description which is set out below, relating to a possible embodiment of the invention illustrated in the attached drawings and provided by way of non-limiting example, in which:

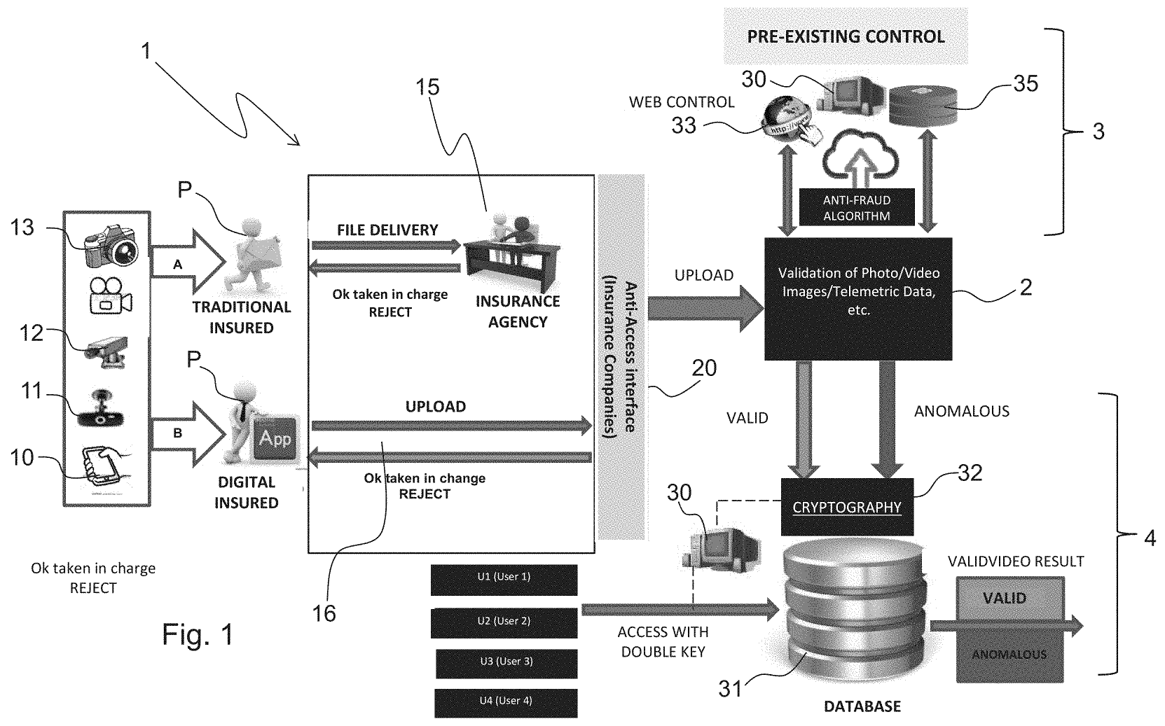

FIG. 1 schematically shows an image acquisition system according to the invention;

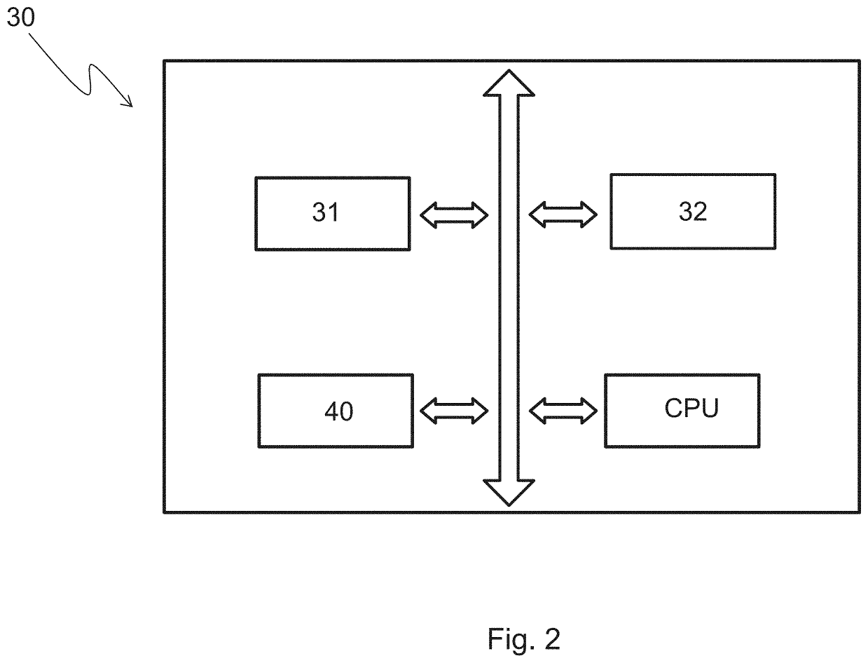

FIG. 2 schematically shows a part of the system of FIG. 1;

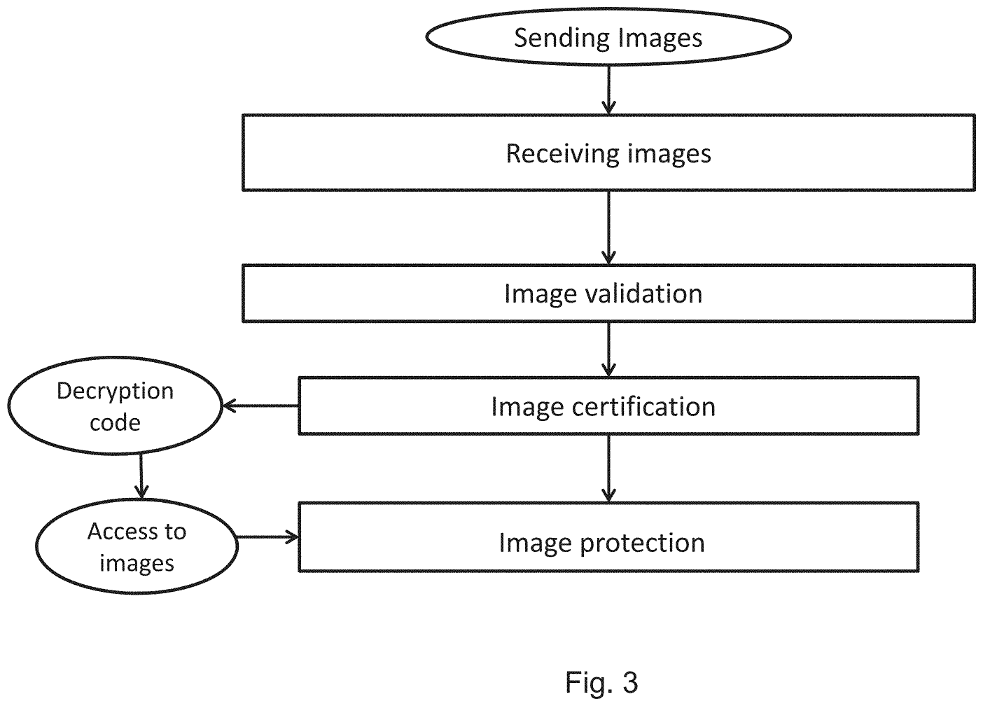

FIG. 3 is a flow chart showing some of the steps of implementing the method according to the invention.

With reference to the figures listed above, the first of them schematically shows an image processing system in accordance with the invention, which essentially comprises three blocks: an image validating block 2, a certifying block 3 and a protecting or security block 4.

Before proceeding to describe what is shown in the figures, it is necessary to specify that even people who are not particularly skilled in the art will recognise that some elements of the figures have been illustrated in enlarged form (i.e. not to scale), for simplicity and clarity's sake.

Likewise, the drawings do not feature common or known elements that are useful or possibly necessary for a more commercial embodiment of the invention, but which those skilled in the art are able to recognise, in order not to burden the explanation and facilitate the understanding of the most relevant features of the invention.

Further, those skilled in the art will recognise that some specific implementations can be implemented through circuit components (i.e. hardware) or through programs (software) applied to one or more of the elements described.

Therefore, the reference to “an embodiment” within this description indicates that a particular configuration, structure or feature shown or described is included in at least one embodiment of the invention.

Similarly, the expressions such as “in one embodiment” and the like, present in different parts within this description, do not necessarily all refer to a single and the same embodiment. Furthermore, the particular configurations, structures or features may be combined in any suitable way in one or more embodiments.

The system of the invention is intended for the processing of video, photographic images and more generally, of data and/or information preferably related to road accidents but not only, coming from various sources.

Hereinafter, for simplicity's sake, reference will be made, as has already been done previously, to a document D to indicate generically the computer element, also called “file” with the Anglo-Saxon name, which is processed by electronic processing means to reproduce the images.

The latter can be acquired in any way, for example with mobile telephony terminals 10, i.e. mobile phones but also electronic tablets, portable computers, etc.; data and/or image acquisition devices 11 such as video cameras (on board vehicles or even separately, of the type known as dash-cam, action-cam, web-cam etc.) but also event recorders such as VEDR, satellite navigators, black boxes and the like; street and/or building surveillance cameras 12; reports, findings and various contributions 13 provided by public authorities (police, traffic police, etc.), rescuers, or other people present at the accident site.

The images and the data coming from all these sources are transmitted to the validating block 2; in practice, the latter receives in the form of electronic documents D (files), incoming images and data relating to an event.

For this purpose, operators 15 can be provided for uploading the electronic documents in the block 2, as shown in FIG. 1; this is however only indicative, since these operators can in any case be replaced by electronic and/or computerised means 16, adapted to carry out the functions of upload of documents in the block 2.

In practice, there can be two alternatives: a first one in which a person P delivers (directly or by regular or electronic mail or other) a document D to the operators 15, responsible for uploading into the system through an interface 20.

The second alternative is that of a solution in which a document D is transmitted directly to the interface 20, by means of an authorised protocol, preferably an application for mobile phones but it could also be an internet site or the like.

In both cases, the person P receives a return communication from the system, as a receipt of acceptance or rejection of the document D (because it is not acceptable, tampered with, unreadable or other).

As is known, in fact, with the progress of technologies, capabilities and performances of computer systems or artificial intelligence, many of the functions performed today by human operators can be replaced with machines, whether they are electronic processors (e.g. servers, computers, etc.), TLC apparatuses, data reception and/or transmission systems and so on.

This also applies, for example, to the operations for the first skimming of the documents coming from the various sources of acquisition of the images 10-13, which can possibly be selected if they do not meet the minimum requirements for the uses that will emerge better later.

In a possible embodiment of the invention, the operators 15 are people who are in places that are distinct and distant from those of the events to which the images refer; think of indicatively locations, or different towns, states or continents, since the system 1 according to the invention is preferably accessible remotely through a telecommunications network, for example through a computer platform or any other internet architecture solution (e.g. public network, intranet, extranet or other).

Consequently, even if in FIG. 1 the various blocks or components of the system 1 are depicted in a neared position, this is simply due to space reasons and the indicators (curly brackets, arrows, etc.) are used to understand the flows of images and/or circulating data, which can be transmitted from one block to another in any appropriate way (via cable, via electromagnetic waves, the combinations thereof and so on).

The validating block 2 comprises at least one processor (e.g. computer, server, calculation centre or other apparatus) adapted to perform the functions necessary to determine whether the images contained in an electronic document D are effectively authentic or have been changed.

Furthermore, the images acquired from the sources 10-13 are preferably uploaded into the validating block 2 according to a protocol which ensures the computer identification of the author of the computer document containing the images, be they photographic images, video, audio and video, or other.

This takes place by releasing a digital identity ID and a personal access code (password) by the system for a user, be it an operator 15 or a person driving a vehicle involved in an accident, or other people (e.g. witnesses, public security authorities, rescuers).

This procedure makes it possible to identify those who send electronic documents to the validating block, also operating the skimming referred to above, to restrict and select the electronic documents to be validated in block 2.

In the diagram of FIG. 1 this logic function is represented by a filter 20 for the access to the validating block 2.A similar filter 40 is preferably provided for the certifying 3 and/or security 4 blocks, at the communication ports with the external users U1, U2, U3, U4.

The validating block 2 therefore processes only pre-selected electronic documents D and is able to guarantee the date and the time of formation of a computer document, as well as to exclude alterations thereof, by analysing preferential parameters.

These parameters comprise one or more of the following: the image-related metadata (e.g. date and/or time and/or place),

the brightness contrasts,

the shadows and statistical dispersion,

the colour space,

the discontinuity points of the images,

congruence of resolutions,

congruence of the frames,

verifying the image pre-existence on databases and on the network.

Where available, these parameters can be integrated and/or crossed with other data or information, such as the telemetric data of a vehicle (speed, acceleration, position, etc.) or an audio track associated with the images.

The validating block 2 performs a series of operations on the uploaded electronic documents, aimed at verifying the authenticity thereof, that is to say, at excluding that they have been tampered with in some way and therefore do not correspond to the original.

For example, a verification consists in determining the type of video sensor that acquired the images by reading this information from the metadata included in the electronic document.

The same is done by analysing the changes that may have been made using a photo/video retouching program (software), since the tools that these programs make available very easily generate changes that remain in the image or in at least one of the frames (in case the video content is a sequence of frames).

The validating block then performs controls on the contrasts present in the images, on the shadows and/or on the statistical dispersion of the figures or on the variation of image definition, as well as the other options listed above.

In this circumstance it should be signalled that preferably, one of these controls provides for verifying the image pre-existence on databases 35 which can be both internal to block 3, therefore private or otherwise protected, and external thereto such as those of images available on the network 33.

In this way, a further control is performed against possible fraud, based on the multiple use of the same image which, even if verified and asseverated for the first time, is clearly not acceptable for subsequent cases.

Further controls can then be made by crossing data, such as comparing the brightness of the images with the place and the time where they were recorded, identifying any incongruent situations such as the presence of sunlight at night or the like.

More generally, all discontinuities or incongruence in the parameters, such as those caused by the removal of frames from a video, are detected to determine whether a document has been tampered with or not.

By doing so, the authenticity of a document is also reliably and systematically detected, which is then validated or rejected by the block 2 depending on the positive or negative outcome of the controls.

In particular, in the positive case the validated document D passes to the following block 3 for the certification thereof; this is a crucial step of the invention.

Since the document comes from any of the sources 10-13, it can be provided with a format (Mpeg or other), size, length, (high, low) definition, with or without audio, telemetric data, and so on, that is not predictable a priori.

It is also reminded that images can be both photographic and video, alone or combined with other data (telemetric, audio) and therefore also for this reason a classification and reduction to default formats is carried out.

Therefore, the block 3 first reduces the document D to a format suitable for the needs of the system 1, that is to say for the uses that the users will have to make thereof.

This applies to both size and length; any other criteria may be chosen as a function of the intended use of the documents.

This operation is preferably performed automatically, i.e. without the interactive intervention of an operator, for example on the basis of information related to an event (be it a road accident or any other event) such as the time when it occurred or the telemetric data (geographic position, speed, acceleration) related to the means for recording the images if they are on board a vehicle, or to those of a moving object whose image is present in the document, or other parameters such as brightness, intensity or the frequency of a sound if there is an audio track associated with the video one, etc.

All these preceding operations and the others that will follow, are preferably implemented through a platform or neural network, so as to optimize the performance and validation times of the documents D.

Alternatively, the reduction of the document to the required format can be performed by authorised and/or specialised operators.

Regardless of this, the document D in the required format is encrypted with a code whose encryption key is available only to an authorised user U, as will be seen better below, who can download it from the certifying block 3 in a traced and traceable manner.

For this purpose, the encryption code C is stored in the certifying block 3 in an area other than that where the corresponding encrypted document D is allocated.

In particular, once the encryption step is completed, the document D is certified by block 3 as it has successfully passed both the verification and validation stage in block 2 as well as the encryption stage with saving of the document and the code thereof in block 3, in respective memory areas 31, 32 to which reference will be better made below.

In accordance with a preferred embodiment of the invention, the encryption is performed on the data in transit from/to the databases contained in one or both of the memories 31, 32.

According to an advantageous solution, the used databases can be of the type that is commercially available, so as to reduce the costs of realisation the system 1.

A possible example of database is the one known as SQL Server 2016 Database Engine Enterprise Edition; obviously other IT solutions could be adopted as an alternative to this one, even if the solutions adopted must preferably provide adequate levels of security.

The recommendations present in the “Common Criteria” (https:// commoncriteriaportal.org) can be advantageously followed for this purpose.

To this end, the system 1 according to the invention comprises processing means 30, such as computer, server and the like, independent or connected to each other on the network, suitable for the purpose as will be better described hereinafter.

It should only be specified that according to a preferred embodiment, in order to increase the level of security the encryption of the data stored in the memories 31, 32, can be implemented by means of the technology known to those skilled in the art with the acronym TDE (Transparent Data Encryption).

Furthermore, in accordance with a preferential embodiment, it is envisaged to increase the protection of specific data, by means of an appropriate technology, which allows to perform some operations and queries on the encrypted data, without making them readable to the operator or system administrator.

Preferably, such a technology is known to those skilled in the art as “Always Encripted”, also available for databases in the already mentioned SQL environment.

It should also be observed that in this condition the document D is not only protected against possible break-ins or tampering, but also against unauthorised viewing by third parties, so that the confidentiality of the data contained therein is ensured.

In this context, it should be emphasized that the aspect of the protection of sensitive data contained in the documents managed in accordance with the invention is a feature of great importance that is not envisaged by the systems known from the state of the art.

In fact, since the system 1 of the present invention is adapted to manage documents coming from external and heterogeneous sources 10-13, also intended for other uses (e.g. video surveillance) other than the main one of interest, it is not possible to follow a procedure such as the one known from US 2003/028298 already referred to initially, as this requires a special and specifically dedicated device (black box type), which acquires images related to the instants immediately preceding and following an accident thanks to a sequence (routine) started by detecting sudden changes in speed, caused by a road accident involving the vehicle where the device is installed.

The acquired images are encrypted and transmitted remotely, without however any control both during transmission and reception.

It is evident that this is not possible in the present invention, which allows to use images also acquired with recording means external to the vehicle, i.e. not on board thereof and therefore fixed, such as for example cameras or video cameras of surveillance systems.

Furthermore, the solution known from US 2003/028298 does not ensure the authenticity of the encrypted and remotely transmitted images.

With reference to FIG. 2 it can be observed that the certifying block 3 and/or the security block 4 comprises electronic processing means 30, preferably consisting of a plurality of server-type computers or the like in communication with each other and displaceable even at a distance from each other, which are suitably programmed to carry out the operating steps explained above.

The processing means 30 comprise the first memory 31 in which the documents D that are validated by block 2 and encrypted are maintained, while the encryption codes of the documents used for the encryption operated by the processing means 30 are stored in the second memory 32, preferably separate from the first.

The first and second memory 31, 32 are preferably organised as databases and can in turn comprise a series of memories, structured with an architecture more suited to the needs, which those skilled in the art are able to design on the basis of common technical knowledge of the sector.

The memories 31, 32 are preferably of the permanent non-rewritable type (ROM) and can also be arranged in different places and/or computer equipment (servers and the like), separated from each other, accessible only to authorised users who are not the same in both cases.

In particular, the first memory 31, which in this example is arranged in the security block 4, can only be accessed by users of the system 1 who, in the case of applications of an insurance type, are responsible for the settlement of claims or disputes such as judges, experts, lawyers or others.

These users can access only one document D at a time, following the receipt of a decryption code coming from the second memory 32.

Access to a document D allocated in the first memory 31 is performed in a controlled and traced manner; this happens preferably with the release by block 4 of access credentials (e.g. a user identification name and a personal PIN code, a mobile phone number, etc.) for a user identified beforehand.

Each access is authorised by the system 1; for example this can be done by sending a message to an accredited mobile phone of the user, or a certified e-mail message (PEC) or other.

The trace of each access (date, time, duration, etc.) is therefore stored, so that any loss of data can be traced.

This way of proceeding ensures a high level of protection of sensitive data that are associated with accidents, especially road accidents; however, this generally applies to any type of event documented with photographic and/or video images, or other data or information, not necessarily a road accident: for example, think of the images documenting the damages to dwellings or buildings in general.

The second memory 32 of the certifying block 3 is preferably accessible only to the manager of the block 3; however, this mainly in order to allow maintenance and/or data saving interventions.

This expedient ensures that the encryption codes contained in the memory 32 are kept secret not only to external users but also to the operators who, in the system 1 according to the invention, deal with other parts or with other blocks 2, 4.

In this way, the encryption codes generated by block 3 are made available only to users who must access the documents D contained in the first memory 31.

The encryption codes contained in the second memory 32 are transmitted by block 3 to accredited users only, when they must have access to the certified documents D present in the first memory 31.

In practice, an accredited user U1, U2, U3, U4 (e.g. an insurance expert, a lawyer, a judge, etc.) who wants to access a specific default document D (i.e. not any other document) allocated in memory 31 of block 4, must be authorised by the system 1.

To this end, an access control procedure must be executed through identification code (PIN or similar) and verification message to a mobile phone T or a recognized e-mail address (Certified E-Mail or other).

Obviously, other access control procedures can be executed as an alternative to, or in combination with, the one just considered.

This takes place through the security block 4 of the system 1 according to the invention.

At the end of the access step, the user U1-U4 authorised by the system 1 receives from the memory 32 the decryption code for the specific document D of interest; also in this case, a confirmation of receipt of the code by the user U1-U4 will preferably be requested, by means of a message with a mobile phone or a personal computer (PC, tablets or the like).

The access is then registered by the system 1 so as to be able to store trace and thus ensure the confidentiality of the data.

Likewise, when the user U1-U4 ends the consultation of the requested document, he is disabled by system 1 and excluded from access, a trace of which is in any case kept (date, start and end time, consulted document, etc.).

From what has been described up to now it is possible to understand how the system 1 according to the invention solves the technical problem underlying it.

In fact, it allows to guarantee the authenticity and storage of documents such as photographic images, videos and other contents, coming from any source 10-13, also making their consultation available in a secure way and protecting the confidentiality of sensitive data associated with the documents.

This significantly expands the applicative possibilities of the use of images, to all those fields where they are to be considered as documentary evidence with official importance.

In fact, the phenomenon of falsification or in any case of alteration of images, videos or documents in electronic format is well known, which are often then disseminated on the network for purposes that are not always lawful.

This situation cannot be accepted in sectors of public interest, where having a guarantee on the authenticity of documentary evidence is needed.

This does not apply only to the insurance field referred to above, but also to other sectors: for example, think of the medical records of hospitals, where radiographic, ultrasound, magnetic resonance images and in general the clinical examination reports, are now available in electronic format. Also in this field it is important to be able to rely on the authenticity of these documents, which contain sensitive data of individuals that are stored in computer systems so as to be available for consultation by third parties.

Similar considerations can be made, mutatis mutandis, for the documentary evidence to be used in court or in that of the security of public places, with the images acquired by surveillance camera systems, mobile phones or other.

In this context, the synergistic effect achieved by the steps of the process of asseverating according to the invention must be highlighted, in which the images are first verified and certified as authentic (i.e. without tampering), and then protected by encryption.

In fact, with the solutions known from the state of the art (e.g. Macky or WO 2018/193412) in which there is no control over the authenticity of the images before storing and/or encrypting them, there is the risk of asseverating altered images or however not corresponding to the original ones.

Otherwise, in the present invention this does not happen thanks to the synergistic effect mentioned above.

Firstly, this allows to have an open asseveration system, that is not limited to images recorded with specific equipment such as those of Macky's, that is to say of the black boxes that are anyway limited sources and intended to be applied on the vehicle.

The invention, on the other hand, makes it possible to use images acquired by any means, even (and above all) external to the vehicle or in any case unrelated to those who want to demonstrate a certain fact: the system therefore becomes open to all contributions, even those coming from third parties.

At the same time, the process of the invention also ensures the protection of personal or otherwise sensitive data contained in the documents coming from external sources.

In other words, despite being an open system, the invention is able to prevent access to documents by unauthorised subjects, with a secure and stable procedure.

Variants of the invention with respect to what has been described so far are also possible depending on the different applications.

Firstly, it is in fact foreseeable that persons skilled in the art will be able to realise the computer architecture of the system 1 with the components thereof (schematically indicated in the operational blocks 2, 3 and 4), in a different way from that shown in the diagram of FIG. 1.

For example, the number and the functions of these blocks may be greater than those mentioned, as well as the memories 31, 32 and the data that are allocated inside them.

In fact, from a technical point of view, multiple solutions are possible to obtain the functions illustrated.

The same applies to the sending and/or upload of video or photographic images, which in principle could be done directly from the acquisition sources 10-13 to block 2, if the security and data protection conditions required for the system 1 according to the invention were met.

For example, these conditions could be met in the case of sending via a fixed terminal (e.g. PC, laptop and the like) or mobile telecommunications (mobile phone, electronic tablet or other device), with an appropriate program or application for the secure sending of documents.

1. A method for asseverating video images, photos, audio-video and/or data in general, acquired from different sources (10, 11, 12, 13), characterised by comprising at least one step of validating the authenticity, one step of certifying and one step of protecting images, which are implemented in combination with each other.

2. The method according to claim 1, wherein the step of validating the authenticity of the images to ensure the absence of tampering, is implemented by a processing procedure, which includes among others:
identifying the source (10-13) of the images,
determining chronological identification parameters of the acquisition time;
verifying any changes or alterations, by analysing one or more parameters associated with the images.

3. The method according to claim 1, wherein the step of certifying comprises:
a reduction of the images to a default format;
an encryption with a code whose decryption key is made available to an authorised user (U) in a traced manner.

4. The method according to claim 1, wherein the step of protecting images comprises:
authorising a user (U1, U2, U3, U4) to access an encrypted document (D);
transmitting a respective document (D) decryption code to the user (U1, U2, U3, U4), after his authorisation;
controlling the access to the document (D) by the user (U1, U2, U3, U4).

5. The method according to claim 1, wherein the step of validating comprises the operations of:
searching for changes within the images by performing a verification of a plurality of data and/or parameters, which are adapted to identify at least one alteration of the content of images after their acquisition, including:
image-related metadata,
brightness contrasts,
shadows and statistical dispersion,
colour space,
discontinuity points of the images,
congruence of resolutions,
congruence of the frames,
verifying the image pre-existence on databases and on the network;
classifying the document (D) of images as altered if it comprises at least one of said changes.

6. The method according to claim 1, wherein the sources (10-13) for acquiring images comprise at least one of: mobile telecommunication terminals (10), such as mobile phones, electronic tablets, laptop computers, etc.; data and/or image acquisition devices (11) on board vehicles, such as video cameras, VEDR-type event recorders, satellite navigators, black boxes and the like; street and/or building surveillance cameras (12); reports, findings and the like (13) provided by public authorities (13).

7. The method according to claim 1, wherein the step of certifying comprises a reduction to a default format of a document (D) containing the images comprised in a time interval over a default moment of time.

8. The method according to claim 7, wherein the format comprises the time duration of the images, and wherein the moment of time is set on the basis of data relating to an event, comprising at least one of:
the time when it occurred, telemetric data relating to the means for recording the images and/or to a moving object present in the images, the brightness of the images, the intensity and/or the frequency of a sound if there is an audio track associated with the images.

9. A system for implementing the method according to claim 1, comprising:
a validating block (2) adapted to receive, in the form of electronic documents (D), incoming images acquired from sources (10, 11, 12, 13) of general purpose, such as mobile telecommunication terminals (10), video cameras on board vehicles (11), fixed surveillance cameras (12), or other (13), wherein the validating block (2) processes the uploaded electronic documents (D) to verify their authenticity ensuring that they have not been tampered, characterised by comprising
a certifying block (3) of the images in communication with the validating block (2), and a security block (4) adapted to communicate with the certifying block (3).

10. The system according to claim 9, wherein the certifying block (3) comprises electronic processing means (30) adapted to perform a reduction of the documents (D) to a default format as regards the size and/or the length.

11. The system according to claim 9, wherein the certifying block (3) comprises electronic processing means (30) adapted to encrypt the documents (D) validated by the validating block (2).

12. The system according to claim 11, wherein the encryption is implemented by a code whose encryption key is available only to an authorised user (U1, U2, U3, U4), who can obtain it from the certifying block (3) in a traced manner.

13. The system according to claim 11, wherein the encryption code (C) is stored in the certifying block (3) in an area (32) other than that (31) where a corresponding encrypted document (D) is allocated.

14. The system according to claim 9, comprising filters (20, 34) for accessing at least one of the validating (2), certifying (3), and security (4) blocks.

15. The system according to claim 9, comprising a neural network structure with which at least one of the certifying (3), validation (2), and security (4) blocks, is associated.
